(19) United States
(12) Patent Application Publication
(10) Pub. No.: US 2006/0226928 A1
(43) Pub. Date: Oct. 12, 2006

(54) Ball coax interconnect

(76) Inventors: Larry C. Henning, Corning, NY (US); Lawrence C. Hughes JR., Corning, NY (US); Karen I. Matthews, Horseheads, NY (US); Deepukumar M. Nair, Peru, IN (US)

Correspondence Address: CORNING INCORPORATED, SP-TI-3-1, CORNING, NY, 14831, US

(21) Appl. No.: 11/101,882

(22) Filed: Apr. 8, 2005

(51) Int. Cl. H01P 5/02; H01P 1/00

(52) U.S. Cl. 333/33; 333/260

(57) ABSTRACT

A pseudo-coaxial vertical transition (10) includes a substrate (16). A bump array is disposed in a substantially concentric bump pattern upon the substrate (16) for simulating a pseudo-coaxial vertical electromagnetic wave propagation. The bump array is formed from a centrally disposed bump (32) having a predetermined bump diameter, and a plurality of at least five ground bumps (36) substantially equi-distant and circularly disposed about the centrally disposed bump (32). The predetermined bump diameter and a bump spacing of the centrally disposed bump are determined in relation to the plurality of ground bumps and a dielectric constant of air for providing a characteristic impedance.

### BACKGROUND OF THE INVENTION

1. Field of the Invention

The present invention relates generally to interconnection devices, and particularly to interconnection devices for mounting high-speed or high-frequency optical-electronic multi-layered assemblies to circuit boards.

2. Technical Background

Rapid advances in technology have accelerated the need for packaging devices which can accommodate, among other factors, connection requirements, higher operating frequencies, such as around 40 GHz, and increases in the numbers of inputs and outputs on integrated circuits (ICs) for optical and electronic circuits. Conventional packaging devices include ball grid arrays (BGA), wire bonding, tape automated bonding (TAB), quad flat packs (QFP) and controlled collapse chip connections (C4 or flip chip). BGA packages tend to be particularly popular because they are easier to surface mount on a printed circuit board than fine pitch peripheral lead packages, such as QFPs. This is because the outer leads of BGA packages are distributed on the lower surface of the package in a matrix, rather than being restricted to the package perimeter and thus being easier to damage. Moreover, since BGA packages do not include peripheral leads, BGA packages take up less room on a printed circuit board, and may be closely spaced. For example, conventional BGA matrices are arranged in linear columns and rows or diagonal lines. This close spacing also allows for shorter interconnect lengths between packages, which results in improved electrical performance.

Conventional packaging technologies, including BGA packages, however, fail to address the specific needs of high frequency integrated optical-electronic assemblies, particularly with respect to providing low loss, reproducible electrical interconnections at the circuit board level for mounting high frequency optical-electronic assemblies. Specifically, known packaging techniques fail to provide the interconnections which would allow high frequency electrical processing, such as signal generation, signal reception, and digital processing or optical processing, such as light modulation, to be combined in a compact space, as in a single circuit board.

Deficiencies can exist with respect to performance in the optical-electronic circuits, particularly at very high frequencies if such interconnections are not properly accommodated. This is because slight variations in signal path impedance may dramatically impact transmission performance. Furthermore, the high frequency interconnection needs to be inexpensive and manufacturable, allowing its use in the commercial market place.

Therefore, there is a need for a low loss, economical device for connecting assemblies on substrate boards which would allow high frequency electrical and optical processing to be combined in a single circuit board.

### SUMMARY OF THE INVENTION

One aspect of the invention is a pseudo-coaxial vertical transition which includes a substrate. A bump array is disposed in a substantially concentric bump pattern upon the substrate for simulating a pseudo-coaxial vertical electromagnetic wave propagation. The bump array is formed from a centrally disposed bump having a predetermined bump diameter, and a plurality of at least five ground bumps substantially equi-distant and circularly disposed about the centrally disposed bump. The predetermined bump diameter and a bump spacing of the centrally disposed bump are determined in relation to the plurality of ground bumps and a dielectric constant of air for providing a characteristic impedance.

In another aspect, the present invention includes the coupling of the pseudo-coaxial vertical transition to a planar transmission line.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operations of the invention.

### BRIEF DESCRIPTION OF THE DRAWINGS

FIG. 1 is a perspective view of a pseudo-coaxial vertical transition 10 that could be used as a circuit device in which an embodiment of the present invention forms a portion;

FIG. 2 is a perspective view of additional layers that can form the pseudo-coaxial vertical transition 10, in accordance with the present invention;

FIG. 3 is a side-view of the pseudo-coaxial vertical transition 10 of FIG. 2, with even more layers, in accordance with the present invention;

FIG. 4 is a side-view of the pseudo-coaxial vertical transition 10 of FIG. 2, with bumps instead of vias interconnecting the intermediate layers, in accordance with the present invention;

FIG. 5 is a bottom planar view of the substrate 14 of FIG. 2, in accordance with the present invention;

FIG. 6 is a top planar view of a co-planar waveguide coupling to the pseudo-coaxial vertical transition of FIG. 2, in accordance with the present invention;

FIG. 7 is a perspective view of a co-planar waveguide with ground coupling to the pseudo-coaxial vertical transition of FIG. 2, in accordance with the present invention;

FIG. 8 is a side view of the co-planar waveguide with ground of FIG. 7, in accordance with the present invention;

FIG. 9 is a perspective view of a micro-strip planar waveguide coupling to the pseudo-coaxial vertical transition of FIG. 2, in accordance with the present invention;

FIG. 10 is a side view of the micro-strip planar waveguide of FIG. 9, in accordance with the present invention;

FIG. 11 is a perspective view of a stripline planar waveguide coupling to the pseudo-coaxial vertical transition of FIG. 2, in accordance with the present invention;

FIG. 12 is a side view of the stripline planar waveguide of FIG. 11, in accordance with the present invention;

FIG. 13 is a perspective view of the top two layers interconnected with the bumps of FIG. 4, in accordance with the present invention;

FIG. 14 is a Smith chart of the HFSS™ modeling results of the reflection coefficient of the device of FIG. 13, in accordance with the present invention;

FIG. 15 is an insertion loss graph of the HFSS™ modeling results of the device of FIG. 13, in accordance with the present invention; and

FIG. 16 is an input return loss graph of the HFSS™ modeling results of the device of FIG. 13, in accordance with the present invention.

### DETAILED DESCRIPTION OF THE PREFERRED EMBODIMENTS

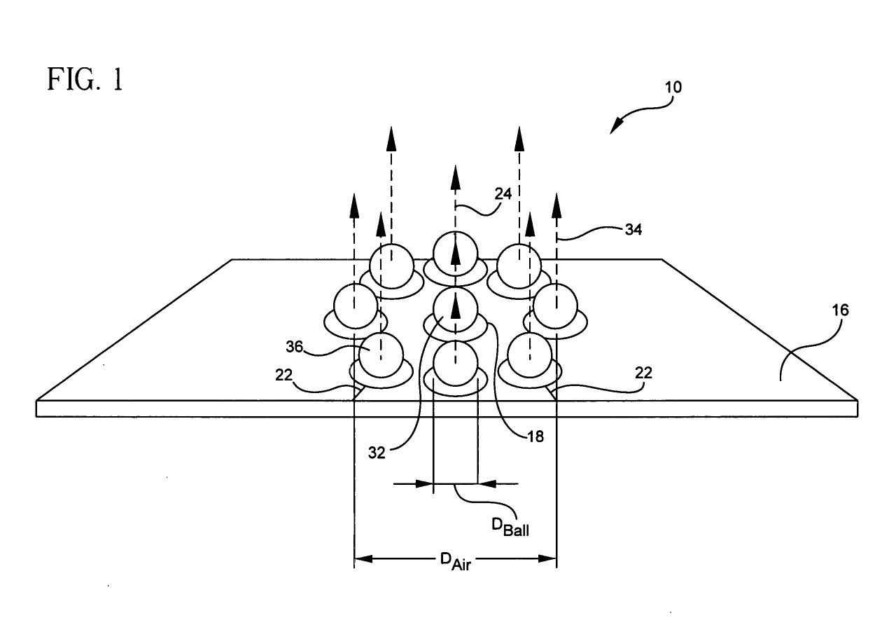

Reference will now be made in detail to the present preferred embodiments of the invention, examples of which are illustrated in the accompanying drawings. Whenever possible, the same reference numbers will be used throughout the drawings to refer to the same or like parts. One embodiment of the pseudo-coaxial vertical transition of the present invention is shown in FIG. 1, and is designated generally throughout by the reference numeral 10.

Referring to FIG. 1, a pseudo-coaxial vertical transition includes a substrate 16. A bump array is disposed in a substantially concentric bump pattern upon the substrate 16 for simulating a pseudo-coaxial vertical electromagnetic wave propagation. The bump array is formed from a plurality of electrically conductive structures including a centrally disposed bump 32 having a predetermined bump diameter d_{ball}, and a plurality of at least five ground bumps 36 substantially equi-distant and circularly disposed about the centrally disposed bump 32. Preferably, the centrally disposed bump 32 and the peripheral bumps 36 have the same predetermined bump diameter d_{ball}. The predetermined bump diameter d_{ball} and a bump spacing D_{AIR} of the centrally disposed bump 32 are determined in relation to the plurality of ground bumps 36 and a dielectric constant of air for providing a characteristic impedance.

“Pseudo-coaxial” for the purposes of this document means that the bumps 32 and 36 are placed in a configuration that resembles a coaxial configuration, whereby the ground bumps 36 are placed in a somewhat ring fashion around the signal or centrally disposed bump 32. “Vertical transition” for the purposes of this document means that the signal flow moves vertically through a flip chip or other substrate or PCB assembly via the bumps 32 and 36. The signal flow may also occur horizontally through various planar transmission lines, forming a “horizontal transition.”

The substrate 16 can be made from any suitable type of materials. Exemplary types of the substrate 16 included a printed circuit board (PCB) or a low temperature co-fired ceramic (LTCC) substrate, which can be a single layer or more practically, a laminated multilayer with DC and AC circuits and transmission lines disposed in various layers.

The bump array simulates a coaxial configuration with a plurality of electrically conductive structures. The electrically conductive structures can be solder balls, conductive resins or polymers.

Circuit lines, including a signal line 18 and ground lines 22, are formed upon the substrate 16, such as on a printed circuit board, in a conventional manner, to provide a characteristic impedance 50 ohms for a transmission line, usable in high speed, high frequency, radio-frequency (RF) or other types of microwave circuits.

The plurality of at least five ground bumps 36 radiate from the centrally disposed bump 32 at about the same radius D_{AIR}/2 for providing the characteristic impedance of about 50 ohms for matching with the transmission line of the substrate 16 and providing a natural ground shield because of the pseudo-coaxial configuration. Hence, in the simple illustrated embodiment of a portion of the microwave circuit, a single signal line 24 is represented functionally to extend vertically through the substrate 16. The solder-ball 32 is positioned between the signal line 24 and the signal line 18 formed upon the printed circuit board 16. The centrally disposed bump or solder-ball 32 forms a vertical signal path permitting conduction of a radio frequency (RF) signal between the signal line 18 and the signal line 24.

To simulate a continuous circle or ring of the outer perimeter of the coaxial configuration, the plurality of ground balls 36 comprises at least five balls substantially circularly, equi-distant, and peripherally spaced around the centrally disposed ball 32. Preferably, the more ground balls 36 there are, the better approximation to a co-axial ring. A plurality, here eight, of ground lines 34, is functionally illustrated in FIG. 1. The lines 34 extend vertically from each of the eight ground bump 36. Each of the ground lines 34 is radially-separated from the signal line 24. In the illustrated embodiment, each of the ground lines 34 is separated from the signal line 24 by about the same radial distance D_{AIR}/2, thereby to be positioned about a common circumference or perimeter. The ground lines 34 substantially surround the signal line 18 in radial directions therefrom. Thereby, the ground lines 34 form a shield about the signal line 24.

Bump or solder-balls 36 are positioned between the ground lines 34 and the ground lines 22 formed on the substrate or circuit board 16. The bumps or solder-balls 36 electrically interconnect the ground lines 34 with the ground lines 22. In manners analogous to the radially-separated positions at which the ground lines 34 are formed relative to the signal line 18, the ground bumps or solder-balls 36 are also radially-separated from the signal bump or solder-ball 32. In like fashion, therefore, to the manner by which the ground lines 34 substantially surround the signal line 18, the ground bumps or solder-balls 36 substantially surround the signal bump or solder-ball 32. Thereby, the ground bumps or solder-balls 36 form a shield about the signal bump or solder-ball 32.

During operation of the pseudo-coaxial vertical transition 10 in a circuit device in which a radio frequency (RF) signal is conducted along the signal line 18, through the centrally disposed signal bump or solder-ball 32, and along the signal line 24, electromagnetic energy is generated as a byproduct of such conduction. Because of the shield formed by the positioning of the ground lines 34 to substantially surround the signal line 18 and of the ground bumps or solder-balls 36 to substantially surround the signal bump or solder-ball 32, the electromagnetic energy is shielded by such ground lines and ground bumps or solder-balls 36. The electromagnetic energy is attenuated and interference which might otherwise occur as a result of the emanation of the electromagnetic energy is substantially reduced. Electromagnetic energy generated elsewhere is analogously attenuated and interferes less with conduction of the radio frequency signal.

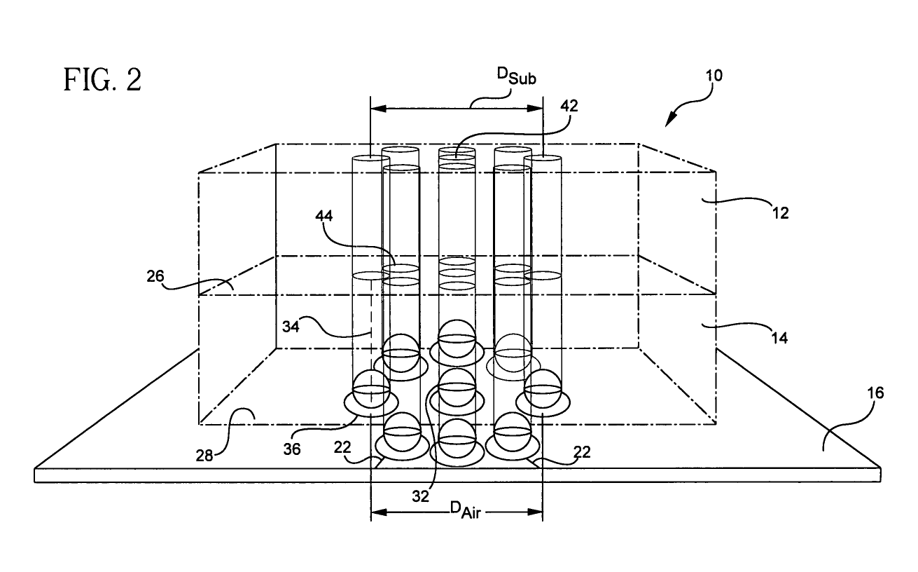

Referring to FIG. 2, a connection assembly utilizing the pseudo-coaxial vertical transition 10 of FIG. 1 is represented. A second substrate which can have multiple layers is added on top of the pseudo-coaxial vertical transition 10 of FIG. 1. For simplicity, only a first layer 12 and a second layer 14 are illustrated. What applies to the first layer 12 also applies to the second layer 14. Referencing only the second or bottom layer 14, the layer 14 has a first surface 28 for interfacing with a high frequency transmission line having a central or signal conductor 18 and a ground conductor 22, a second surface 26 for coupling to the high frequency transmission line, and a body, made up of the layer 14, confined by the first and second surfaces 28 and 26 and having a substrate dielectric constant. The substrate or layer 14 has a plurality of electrically conductive vias 42 and 44 disposed in a substantially concentric substrate array in the body porting into the first and second surfaces 28 and 26. The plurality of electrically conductive vias include a centrally disposed via 42 having a predetermined substrate diameter d for interconnecting with the central or signal conductor 18 of the transmission line, and a plurality of ground substrate vias 44 spaced about the centrally disposed via 42 for interfacing with the ground conductor 22 of the transmission line. The predetermined substrate diameter d of each of the vias and a substrate spacing D or D_{sub} of the centrally disposed via 42 is determined in relation to the plurality of ground vias 44 and the substrate dielectric constant for electrically matching an impedance associated with the high frequency transmission line. Preferably, each of the electrically conductive vias 42 and 44 is an electrically conductive coated cylinder, a through-hole with conductive paste poured through or a variation of any other type of conductive passageways. The vias 42 or 44 is thus a thru-hole bored, or otherwise formed, and filled or plated with an electrically-conductive material.

As in FIG. 1, a ball array having a plurality of electrically conductive structures are disposed in a substantially concentric ball array for coupling to at least one of the first or second surfaces 28 or 26 of the substrate or layer 14. The plurality of electrically conductive structures includes a centrally disposed spherical ball 32 having a predetermined ball diameter d_{ball} for coupling to the central or signal conductor 18 of the transmission line, and a plurality of ground balls 36 disposed about the centrally disposed ball 32 for coupling to the ground conductor 22 of the transmission line, wherein the predetermined ball diameter d_{ball} and the ball spacing D_{AIR} of the centrally disposed ball 36 is determined in relation to the plurality of ground balls 36 and a dielectric constant of air for electrically matching the impedance associated with the high frequency transmission line and the impedance associated with the substrate or layer 14.

An exemplary radio frequency circuit device of which an embodiment of the present invention forms a portion is thus shown. Embodiments of the present invention may similarly form portions of other circuit devices of other constructions.

The exemplary circuit device includes multiple layers of isolating dielectric materials, here preferably formed of ceramic materials, such as in a multi-layered stack of low temperature co-fired ceramic substrate. The layer 12 is cascaded upon the layer 14. A plurality of circuit elements (not shown) which together form at least portions of an electrical circuit are formed on one or more face surfaces of the layers 12 and 14.

The layer 14, together with the layer 12 cascaded thereupon, is surface-mounted upon a printed circuit board 16 as the first substrate including the signal line 18 and ground lines 22.

In the illustrated embodiment, a single signal line 24 is represented functionally to extend vertically through the layer 14 between a top face surface 26 of the layer 14 and a bottom face surface 28 thereof. A signal line 24 is formed of a via 42 extending through the layer 14.

A solder-ball 32 is positioned between the signal line 24 and the signal line 18 formed upon the printed circuit board 16. The solder-ball 32 forms a signal path permitting conduction of a radio frequency signal between the signal line 18 and the signal line 24.

A plurality, here eight, of ground lines 34, is also functionally illustrated. The lines 34 also extend between the top and bottom face surfaces 26 and 28 of the layer 14 through the vias 44 and coupling with each of the eight solder balls 36. Solder-balls 36 are positioned between the ground lines 34 of the layer 14 and the ground lines 22 formed on the circuit board 16. The solder-balls 36 electrically interconnect the ground lines 34 with the ground lines 22.

No additional traces of an electrically-conductive material, such as a solder material need to surround the ground balls 36, because at least five balls and preferably eight will be sufficient to provide the coaxial ground.

A coating of electrically-conductive material is selectively formed upon the top face surface 26 of the layer 14 of the isolating dielectric material at the output of each of the vias 42 and 44. The coating is applied, for example, by a thick-film plating process. The coating includes a centrally-positioned conductive portion for coating the central or signal via 42 and applied at a location at which the signal line 24 opens at the top face surface 26. Analogously, a plurality of circumferentially-positioned coatings of electrically-conductive material are applied to the ground vias 44 and are formed upon the top face surface 26 at the locations of the top face surface at which the ground lines 34 open at the top face surface. The coated portions of the ground vias 44 are each radially-separated from the coated portion of the signal or central via 42 at a common distance from the coated portion of the signal or central via 42, thereby to be circumferentially-positioned about the coated portion of the signal or central via 42. Thereby, the coated portions of the ground vias 44 substantially surround the coated portion of the central or signal via 42. Hence, each ball 32 or 36 of the ball array is axially and vertically aligned with each via 42 or 44 of the plurality of electrically conductive vias.

While not illustrated in FIG. 2, signal and ground lines, analogous to the signal and ground lines 24 and 34 forming portions of the layer 14, also extend through the layer 12. The coated portions of the central via or signal via 42 and of the ground vias 44 electrically interconnect such signal and ground lines, respectively, with corresponding ones of the signal and ground lines 24 and 34 extending through the layer 14. In such a manner, a radio frequency signal can be conducted between the signal line 18, through the solder-ball 32, through the signal line 24, through the coated portion of the signal or central via 42, and to a signal line extending through the layer 12. Because the ground solder-balls 36, ground lines 34, and coated portions of the ground vias 44 substantially surround the signal path formed through the circuit device, electromagnetic energy generated as a by-product of conduction of a radio frequency signal along the signal path is attenuated and is less likely to interfere with operation of circuit elements of the circuit device.

Multiple numbers of layers, similar to the layers 12 and 14, can be cascaded in manners analogous to the layers 12 and 14. For example, a multi-layered stack of low temperature co-fired ceramic substrates can be laminated together as a unit to form the body portion. Signal paths can similarly be formed to extend through such additional layers of isolating dielectric material.

As in FIG. 1, circumferentially-positioned, electrically-conductive ground lines can be similarly formed to extend therethrough all the various layers. Electromagnetic energy generated as a byproduct of conduction of a radio frequency signal along signal lines formed to extend through such additional circuit layers are attenuated by the shield formed of the ground lines positioned thereabout and radially-separated therefrom.

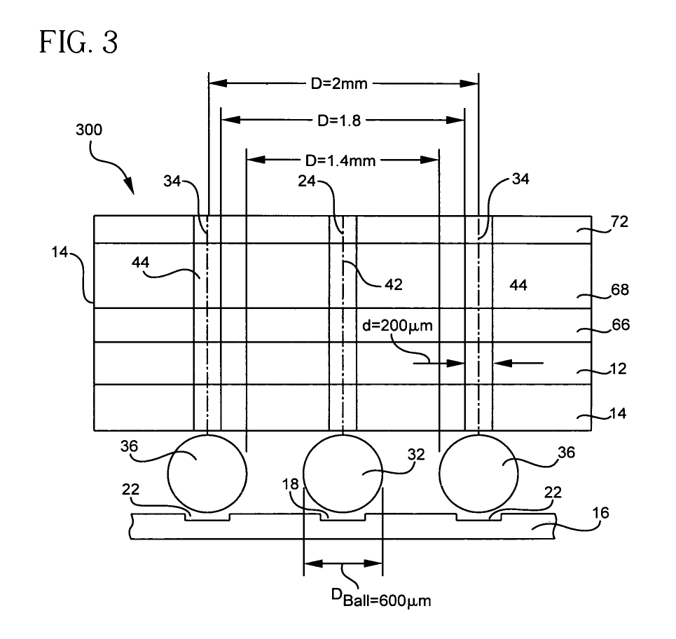

Referring to FIG. 3, a circuit device 300 in which an embodiment of the present invention also forms a portion is shown. The circuit device 300 includes cascaded, layers 14, 12, 66, 68 and 72, as the substrate mounted upon a printed circuit board 16. The layers 14, 12, 66, 68, and 72 are formed of an isolating dielectric material having a dielectric constant.

A signal line 18 and ground lines 22 are formed upon the printed circuit board 16. Vias forming a signal line 24 and ground lines 34 are formed to extend through the circuit layer 14, as described previously with respect to the circuit device shown in FIG. 2. A centrally-positioned solder-ball 32 interconnects the signal line 18 with the signal line 24. Similarly, circumferentially-positioned solder-balls 36 axially interconnect the ground lines 22 with the ground lines 34. A radio frequency signal can thereby be conducted along a signal path formed of the signal line 18, solder-ball 32, and signal line 24.

The circuit device 300 further includes a centrally-positioned coated portion of the central via 42 and circumferentially-positioned coated portions of the ground vias 44 formed between the layers 12 and 14. The coated portions of the central via 42 and ground vias 44 electrically interconnect the signal line 24 and the ground lines 34, respectively, with corresponding, and here similarly numbered, lines extending through the circuit layer 12.

The coated portions of the central via 42 and the ground vias 44 are formed to be laminated, soldered, or otherwise electrically connected between the other cascaded layers of the circuit device 300. As illustrated, the coated portions of the vias 42 and 44 are interconnected between the circuit layers 12 and 66, between the circuit layers 66 and 68, and between the circuit layers 68 and 72. The circuit layers 66, 68, and 72 also include signal and ground lines 24 and 34 extending therethrough.

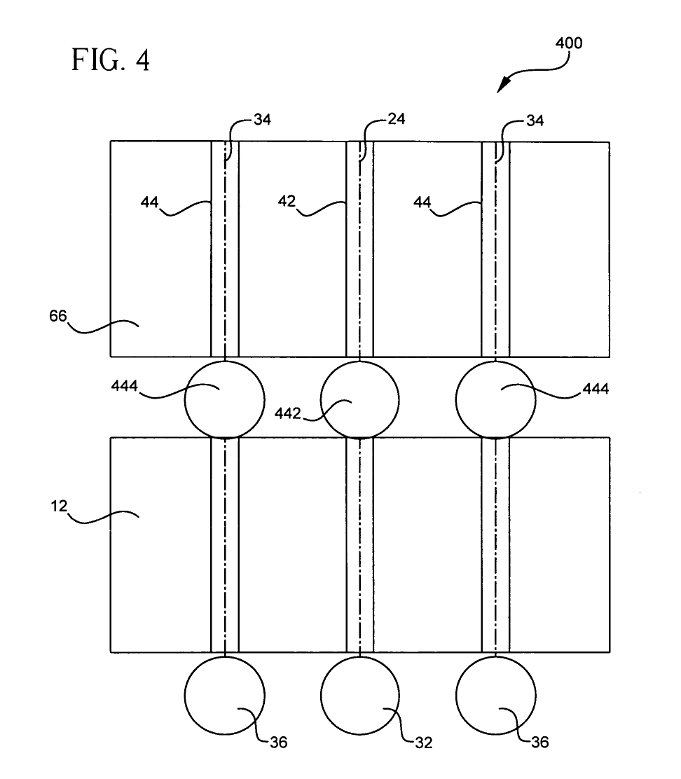

Referring to FIG. 4, instead of directly connected as in FIG. 3, a central solder ball 442 and a plurality of ground solder balls 444 are formed to be positioned between the other cascaded layers of the circuit device 400. As illustrated, the solder balls 442 and 444 are positioned between the circuit layers 12 and 66. The circuit layers 12 and 66 also include signal and ground lines 24 and 34 extending therethrough.

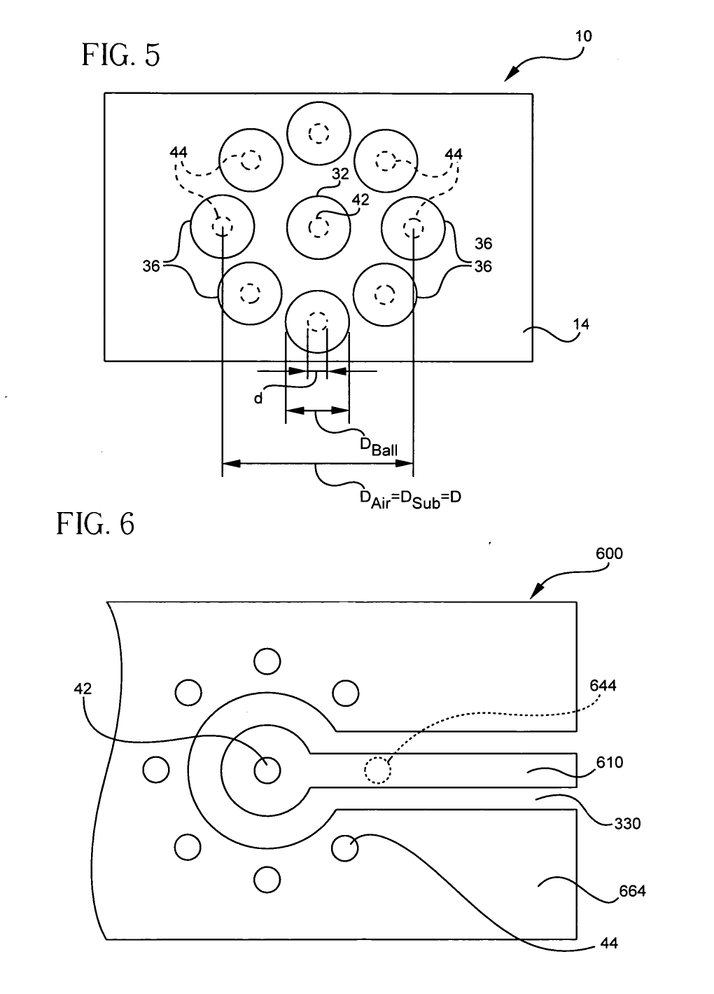

Referring to FIG. 5, a bottom planar view of the substrate or layer 14 of FIG. 2 is shown to illustrate the spatial relationship of the pseudo-coaxial vertical transition 10. A pseudo-coaxial relationship is shown between the centrally-positioned coated portion of the central via 42 and the separate and independently circumferentially positioned coated portions of the ground vias 44. The relationship between the solder balls 32 and 36 can similarly be illustrated.

The diameter of the coated portion of the central via 42 has a diameter, d. The radial enclosure formed of the coated portions of the ground vias 44 is defined by a Diameter, D. Appropriate selection of the respective diameters, D and d, permits the characteristic impedance of the combined structure, here forming a connection between the vias 42 and 44 of adjacently-positioned layers. In similar fashion, the solder balls 32 and 36 form a connector assembly connecting lines 24 and 34 to the lines formed on the printed circuit board 16 of FIG. 2. Analogously, the lines 24 and 34 of a middle positioned layer permits interconnection of corresponding lines 24 and 34 of the circuit layers positioned above and beneath respectively, such middle positioned layer in FIG. 2.

The coated portion of the central via 42 and the radially-extending enclosure of the ground vias 44 are coaxially formed. Because of such a coaxial nature, the assembly, defined of the just-noted manners, exhibits a characteristic impedance defined by the following equation:
Z₀=(⁶⁰/√εᵣ)ln(D/d)
As the equation indicates, the characteristic impedance, Z₀, of the connector assembly can be formed to be of any desired value by proper selection of the values of the respective diameters. For instance, if portions of the circuit device of which the connector assembly, however defined, is of a characteristic impedance of 50 ohms, suitable selection of the respective diameters permits the characteristic impedance of the connector assembly also to exhibit a characteristic impedance of 50 ohms. By matching the characteristic impedance, signal loss of the radio frequency signal conducted along a signal line extending through the circuit device is minimized.

Referring to FIG. 6, a top layer 12 of FIG. 2 is a planar high frequency transmission line having a central conductor 610 and a ground conductor 664. Specifically, the planar transmission line in FIG. 6 is a coplanar waveguide (CPW) for allowing the signal flow to occur horizontally through the transmission lines, forming a “horizontal transition” from the vertical transition below provided by the central via 42 and ground vias 44.

This top view of the CPW 600 is included in an exemplary embodiment of a flip chip or any other type of multi-layered interconnection assembly. The CPW 600 includes the central conductor 610 which can be linear or have a portion to form a radial transmission line on which is disposed the signal bump or centrally disposed via 42. As in other CPW's, the CPW 600 includes exposed substrate 330 having a gap surrounding the radial transmission line 610. Multiple ground bumps or vias 44 and 644 are arranged around the signal bump or via 42 so as to effect a pseudo-coaxial vertical transmission.

According to the teachings of the present invention, the ground via 644 underneath the signal conductor 610 is not exposed through the signal conductor 610 but is terminated, at a suitable distance, for example twice the gap distance 330, in the dielectric layer beneath the metallic layer of the signal conductor 610. Hence, the interconnection assembly for a co-planar waveguide (CWG) forming a high frequency transmission line has at least one ground substrate via 644 recessed below the signal conductor 610 of the CWG 600 to maintain the circular pattern of the ground vias 44 and 644.

Even though FIG. 6 depicts eight ground bumps or vias, other numbers of ground bumps may be used. For example, but not limited to these numbers, five, or more than eight ground bumps may also be employed in other embodiments of the invention.

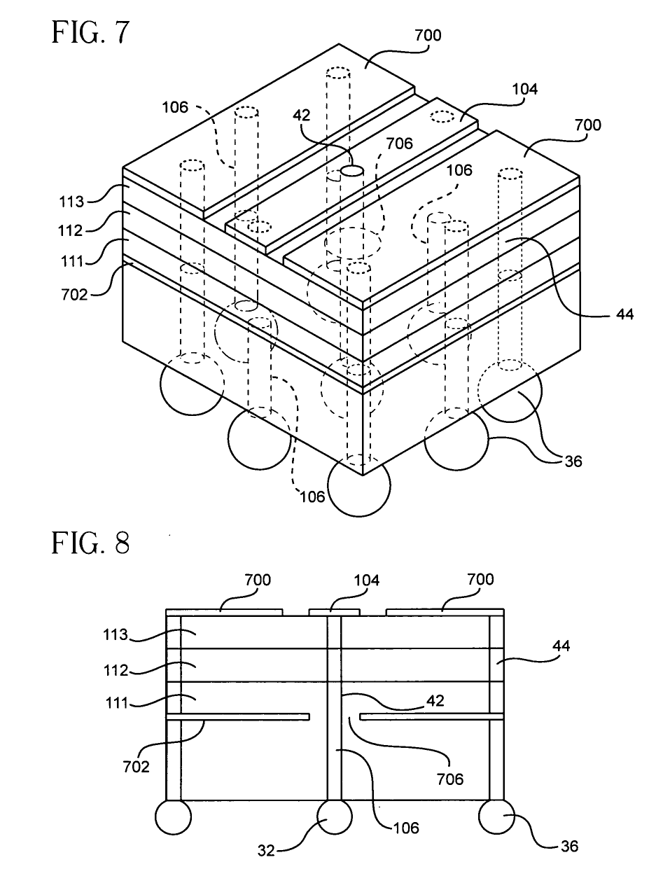

Referring to FIG. 7, the planar high frequency transmission line of the top layer 12 of FIG. 2 is now a coplanar waveguide with ground (CPWG) for allowing the signal flow to occur horizontally through the transmission lines, forming a “horizontal transition” from the vertical transition below provided by the central via 42 and ground vias 44. The perspective view of a high frequency multilayer circuit structure in accordance with a preferred embodiment of the present invention is shown in FIG. 7, and FIG. 8 is a sectional view of the high frequency multilayer circuit structure of FIG. 7.

Referring to FIGS. 7 and 8 together, the high frequency multilayer circuit structure includes upper ground conductors 700, a lower ground conductor 702, a Coplanar Waveguide (CPW) signal line conductor 104, vias 44 for connecting the upper and lower ground conductors 700 and 702, and a first to a third layer green sheets 111 to 113 that are suitable to make low-temperature co-fired (LTCC) layers or other types of ceramic substrates.

The high frequency multilayer circuit structure is formed in such a way that the first to third layer green sheets 111 to 113 are laminated sequentially. Then, the lower ground conductor 702 is formed beneath the first layer green sheet 111, and the upper ground conductors 700 and the CPW signal line conductor 104 are formed on the third layer green sheet 113. Preferably, the CPW signal line conductor 104 is located within a gap between the two upper ground conductors 700.

The vias 44 are formed across the first to third layer green sheets 111 to 113, and are filled or plated with a conductive material. A diameter of each of the vias 106, 44, 42 is preferably about 100 to 200 μm.

However, according to the teachings of the present invention, at least one ground substrate via 106 is recessed below the signal conductor 104 and the lower ground conductor 702 of the CWGG to again maintain the radial pattern of the ground vias 44 and 106. Furthermore, the lower ground conductor 702 has an aperture or otherwise cut-away exposed dielectric area 706 for allowing the central or signal via 42 to be formed across the first to third layer green sheets 111 to 113, and to be filled or plated with a conductive material, without shorting to the ground conductor 702. Hence, the high frequency transmission line is a co-planar waveguide with ground (CWGG) having at least one ground substrate via 106 recessed below the signal conductor 104 and the lower ground conductor 702 of the CWGG, wherein the lower ground conductor has an aperture 706 for allowing the centrally disposed via 42 to protrude to the signal conductor 104.

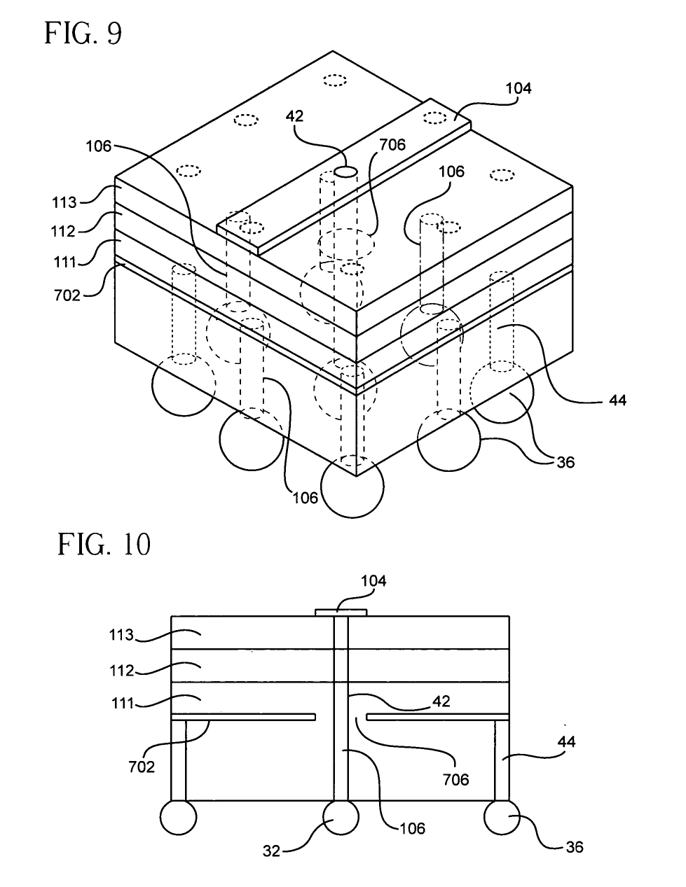

Referring to FIG. 9, the planar high frequency transmission line of the top layer 12 of FIG. 2 is now a micro-strip line for allowing the signal flow to occur horizontally through the transmission lines, forming a “horizontal transition” from the vertical transition below provided by the central via 42 and ground vias 44 of FIG. 1. The perspective view of a high frequency multilayer circuit structure in accordance with a preferred embodiment of the present invention is shown in FIG. 9, and FIG. 10 is a sectional view of the high frequency multilayer circuit structure of FIG. 9.

Referring to FIGS. 9 and 10 together, the high frequency multilayer circuit structure includes a lower ground conductor 702, a micro-strip signal line conductor 104, vias 106 for connecting to the lower ground conductor 702, and a first to a third layer green sheets 111 to 113 that are suitable to make low-temperature co-fired (LTCC) layers or other types of ceramic substrates.

The high frequency multilayer circuit structure is formed in such a way that the first to third layer green sheets 111 to 113 are laminated sequentially. Then, the lower ground conductor 702 is formed beneath the first layer green sheet 111, and the micro-strip signal line conductor 104 are formed on the third layer green sheet 113. Preferably, the micro-strip signal line conductor 104 is located at a gap distance above the lower ground conductors 702.

The centrally disposed or signal via 42 is formed across the first to third layer green sheets 111 to 113, and are filled or plated with a conductive material. A diameter of each of the vias 106, and 42 is preferably about 100 to 200 μm.

However, according to the teachings of the present invention, all of the ground substrate vias 106 are recessed below the signal conductor 104 and opens into the lower ground conductor 702 of the micro-strip to again maintain the radial pattern of the ground vias 106. Furthermore, the lower ground conductor 702 has an aperture or otherwise cut-away exposed dielectric area 706 for allowing the central or signal via 42 to be formed across the first to third layer green sheets 111 to 113 to interconnect with the signal conductor 104, and to be filled or plated with a conductive material, without shorting to the ground conductor 702.

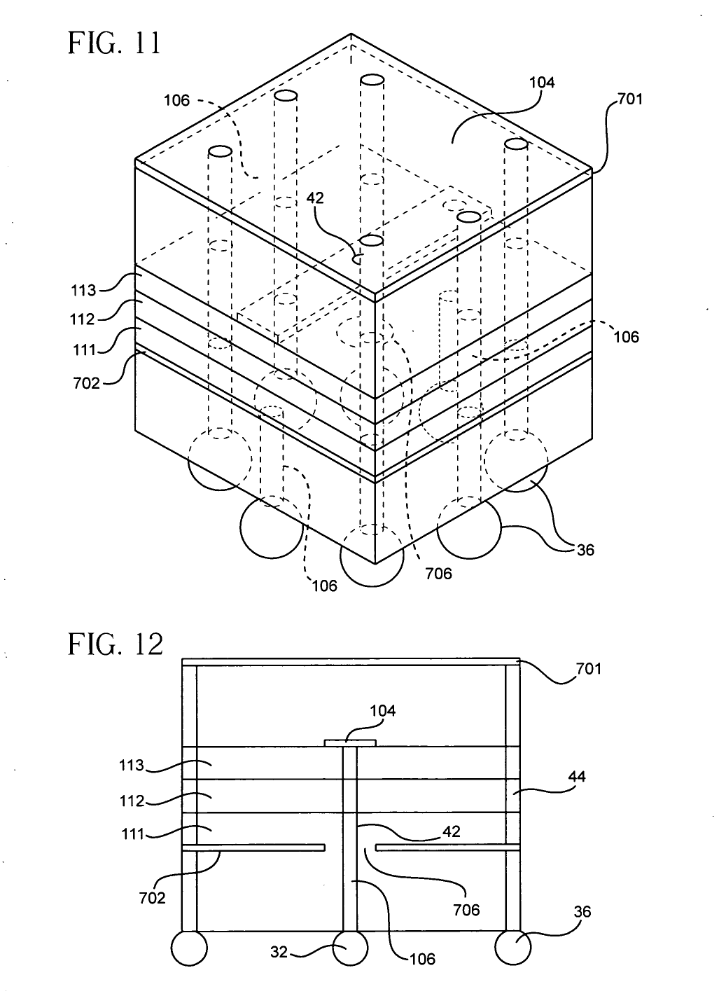

Referring to FIG. 11, the planar high frequency transmission line of the top layer 12 of FIG. 2 is now a stripline for allowing the signal flow to occur horizontally through the transmission lines, forming a “horizontal transition” from the vertical transition below provided by the central via 42 and ground vias 44 of FIG. 1. The perspective view of a high frequency multilayer circuit structure in accordance with a preferred embodiment of the present invention is shown in FIG. 11, and FIG. 12 is a sectional view of the high frequency multilayer circuit structure of FIG. 1.

Referring to FIGS. 11 and 12 together, the high frequency multilayer circuit structure includes upper and lower ground conductors 701 and 702, a stripline signal line conductor 104, vias 106 for connecting to the lower ground conductor 702, and a first to a third layer green sheets 111 to 113 that are suitable to make low-temperature co-fired (LTCC) layers or other types of ceramic substrates. Everything is the same as in FIGS. 9-10, except that an additional upper ground conductor 701 is now disposed above the signal conductor 104. The ground conductors 701 and 702 are preferably vertically equidistant from the stripline signal line conductor 104, and these ground conductors 701 and 102 are interconnected with conductively filled or plated vias 44. Furthermore, the lower ground conductor 702 has an aperture or otherwise cut-away exposed dielectric area 706 for allowing the central or signal via 42 to be formed across the first to third layer green sheets 111 to 113 to interconnect with the signal conductor 104, and to be filled or plated with a conductive material, without shorting to the ground conductor 702.

Hence, referring to all of the FIGS. 1-12, and especially FIG. 2, a high frequency ball coax interconnect produces a low loss, 50 ohm, reproducible electrical interconnect to a circuit board 16 and a coaxial transmission line, such as co-axial solder balls 42 and 44 of FIG. 4, a co-axial connector (not shown) or a planar transmission line on the top layer 12, such as a microstrip of FIG. 9 and/or co-planar waveguide (CPW) 600 of FIG. 6. Since the coaxial interconnection ball grid array is generally implemented as a part of a larger ball grid array, high frequency signal reception, signal and optical generation and optical and digital processing can be combined in a single electronic component, such as a circuit board or any other high-frequency substrate material 16.

To allow design flexibility, circuit routability or the heat dissipation without an additional component of a thermoelectric cooler (TEC), the bumps 32 and 36 and metal through-holes (vias—such as a solid post) 42 and 44 carry signals and ground currents, as well as heat, from a die (not shown) that is mounted on the top surface of layer 12. For example, the die is a high-speed power amplifier or a laser, without a temperature cooler, dissipating excessive heat that would have to be separated from control signals and optical circuits, such as a semiconductor optical amplifier, disposed on the printed circuit board 16 below. The vias 42 and 44 act as electrical and thermal vias. This is important because the device mounted on top heat up in operation, and the preferred package does not have a cooler in it to reduce size and cost. The vias 42 and 44 thus provide a thermal path from the die (that would be mounted on the top side of the LTCC substrate 12, for example) to the bottom of the package (or to wherever the vias 42 and 44 terminate), as in the bumps 32 and 36 disposed on the printed circuit board or substrate 16.

A coaxial-like interconnection is thus formed from a plurality of solder balls configured in an almost circular or ring-like pattern. In prior designs, the solder balls were configured in a 3×3 square array with eight balls or in an attempted circular array with an extra circular trace, with four balls on the printed circuit board. However, because the four balls were still in two linear lines of a much larger matrix, whether diagonal or straight, the pattern formed is still not sufficiently approximating a circle but produced losses as in a square formed from the four corners of the square where each of the balls were selected from the larger matrix.

In contrast, the technology of opto-electronic circuitry is advancing, and hence, the inventors of the present invention overcame the constraining linear matrices of traditional electrical printed circuit boards with a true circular pattern on the bottom substrate or printed circuit board 16. Hence, the coaxial interconnection solder ball grid array includes a single centrally disposed solder ball 32 for interconnecting with a centrally disposed conductor 18 of a coaxial or any other transmission line and a plurality of solder balls 36 surrounding the single centrally disposed solder ball 32, each connected with a coaxial ground shield of the coaxial line 22. The center conductor of the coaxial interconnect is formed via the center ball 32 in a circular pattern of ground balls 36, around the center ball 32 on a substrate 16. Grounding is made by the outer perimeter of balls 36.

The balls' diameters and pitch or spacing has been designed such that these interconnects can be used at high frequencies. These balls 32 and 36 can be varied in size and pitch as long as they maintain 50 ohms. The ball coax can be connected to various microstrip, CPW, and other planar transmission lines and circuit board designs, depending on the application. Hence, a simple way to utilize a circular ball grid array for high speed interconnects by not constraining the printed circuit board or other substrate to have solder balls or solder ball pads arranged in a linear fashion. The resultant integration method allows for a high speed connection to various components within a material structure without changing mediums and with minimal loss.

Hence, according to the teachings of the present invention, a circular patterned BGA (ball grid array)—ceramic substrate coax design is taught that provides improved high speed/frequency performance. For example, in the simulated evaluation of the present invention, for eight ground balls, there were no resonances at 24 GHz and 35 GHz found to increase loss in the inventive circular ground ball/via pattern.

In accordance with the teachings of the present invention, a circular coaxial-style pattern that is normal to the plane of the substrate or PCB material 16 is formed using a combination of plated through or filled vias 42 and 44 and conductive balls (BGA) 32 and 36 that terminate on the top or bottom of the vias 42 and 44 and the interfacing surface of the PCB or substrate 16. The center conductor 18 of the coaxial interconnect is formed with the center ball 32 centered in the circular pattern of the ground balls 36 on the substrate 16. Hence, the ground is formed by the outer perimeter of balls 36.

A main advantage of this invention is that the ball coax concept addresses the cost and size constraints related to conventional “V” or “K” style miniature RF/microwave package connectors and the interface cables and connectors associated with system level interconnects which forces the package to be of a certain size to side-connect with these conventional connectors. In contrast, the inventive BGA-ceramic substrate coax interconnect allows for surface mountable quality high speed interconnections.

The improved structure would be used to unitize the electrical interconnect to a single physical interface. This would permit the final unit to be fully surface mountable.

The present invention teaches how to build controlled impedance interconnects based on predetermined pitch, diameter, and other dimensional parameters of the ball arrays 32 and 36 and substrate via structures 42 and 44. The interconnect uses a “ground fence” design in both the substrate 16 and ball array 32 and 36 to form the outer or ground conductor. Inner conductor balls 32 and vias 42 would also be sized for the desired characteristic impedance. Transitions between the via structures 42 and 44 and external ball 32 and 36 and surface micro-strip, CPW, and other planar transmission line structures are also taught.

The initial High Frequency 3D Electromagnetic Simulation Software (HFSS™) simulations for a Low Temperature Co-fired Ceramic (LTCC) substrate—BGA coaxial interface of the improved structure were started with an LTCC substrate having a specified dielectric constant, an inner conductor ball 32 having a diameter d_{ball} of 600 μm, and eight outer “ground fence” balls 36 having a diameter d_{ball} of 600 μm, and via diameters d of 200 μm. The axial line of the balls 32 and 36 with the appropriate size, spacing or pitch, line up with the axial line of the vias 42 and 44 coming out of the LTCC layer or other substrate 14.

According to the teachings of the present invention, as partially represented in FIGS. 3 and 5, the parameters that need to be considered but are adjustable in design are primarily the via size, the via spacing and the ball size and spacing. The diameter via, d, of 0.2 mm (200 μm) correlates to an outer shield (“ground fence” via pattern) diameter, D, of 2 mm for the LTCC having a dielectric constant of 7.4. For the BGA balls 32 and 36, a dielectric constant of 1 for air was used to determine the ball size diameter of 0.6 mm that correlates with the required 2 mm diameter, D, of the LTCC ground via pattern. For a ball size of 0.6 mm, the corresponding inner diameter for the air coax design is 1.4 mm. This number aligns perfectly with the 2 mm diameter LTCC ground via pattern (outer diameter) and the inner diameter in air: 2 mm−2*(0.3 mm ball radius)=1.4 mm.

The size of the balls can be increased as necessary by simply increasing the radial dimension of the vias in the LTCC. There is, however, a limit. One cannot expect to propagate frequencies in the desired 40 GHz band if one makes the diameter of the “coaxial line” too large. This is due to mode limits of a coaxial waveguide—the frequency bandwidth is inversely proportional to the diameter of the coaxial waveguide or transmission line. With microwave connectors, such as SMA, K and V connectors, the higher the frequency, the smaller the diameter of the coaxial connector; thus, setting the limit on high speed/high frequency lines.

### EXAMPLES

The invention will be further clarified by the following examples.

### Example 1

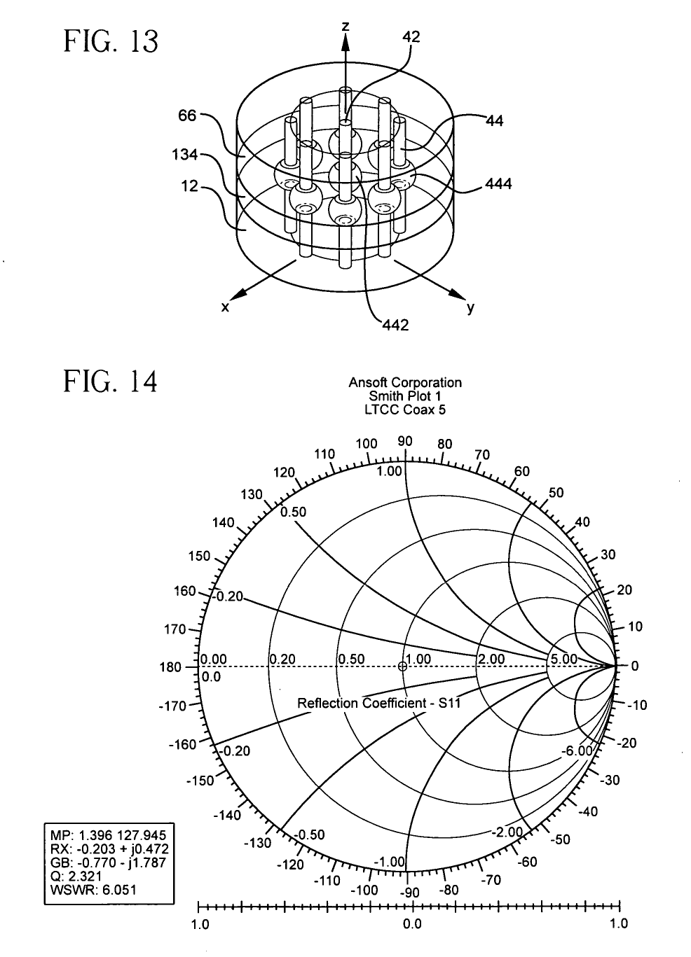

Referring to FIGS. 13-16, the initial High Frequency 3D Electromagnetic Simulation Software (HFSS™) simulations for a Low Temperature Co-fired Ceramic (LTCC) substrate—BGA coaxial interface of the improved structure are shown.

Referring to FIG. 13, a 3D schematic of the inventive circular ball coax design is represented with the HFSS™ model containing a three layer structure. The bottom and top layers 12 and 66 are LTCC, and the middle layer 134 is air. Cylinders are plated through or filled hole vias 42 and 44, balls 442 and 444 are BGA balls. Wave injection ports are on the top and bottom (Z=0 and 2.5 mm) and are normal to the direction of wave propagation in the Z axis. The LTCC substrate thicknesses are 1 mm (independent of design) and the thickness of the air substrate is 0.5 mm. The balls sit slightly inside the LTCC vias, 0.05 mm on top and bottom.

Referring to FIG. 14, the HFSS™ modeling results of the reflection coefficient with the parameters of FIG. 13 are shown. The Smith chart shows the reflection coefficient (S11) is nearly 50 ohms across the 1-40 GHz simulation band as indicated by the small circle surrounding the center of the Smith Chart—which is exactly 50 ohms. Associated return loss (dB(S11)) is better than −30 dB.

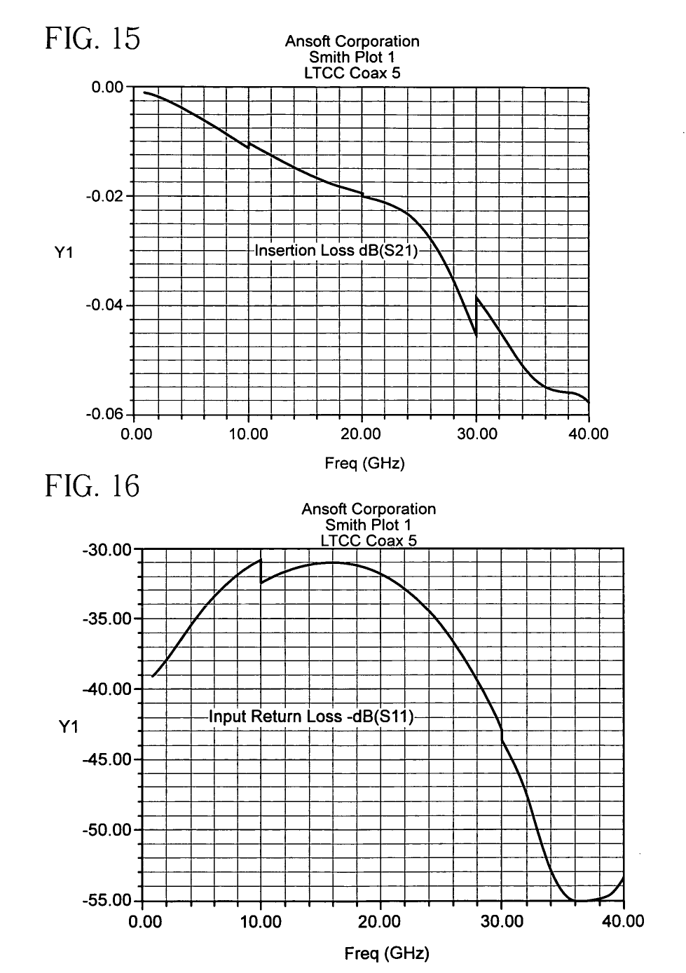

Referring to FIG. 15, a graph of insertion loss dB(S21) from 1-40 GHz is shown for the HFSS™ model of FIG. 13. As can be seen, the “circular” ground coax with eight ground balls has no degradating resonances at 24 GHz and 35 GHz (as does the prior art “square coax”), or anywhere else. The discontinuities in the graph at 10, 20, and 30 GHz, are only due to piece-meal simulations. HFSS™ cannot simulate the entire 1-40 GHz band, it must be segmented due to various software tool limitations),

Referring to FIG. FIG. 16, a plot for the input return loss of the circular ball coax design is shown for the HFSS™ model of FIG. 13.

When comparing a four or eight square ground ball structure to the S-parameters of the invented circular structure, exemplified with eight ground balls, there is an improvement in the forward and reflected responses. The eight ground balls of the “square” ground coax has about more than 5 dB of return loss (S11) worse than the inventive eight circular ground ball design, and the insertion loss dB(S21) is about twice as lossy as the inventive eight circular ground ball design. It should be noted that both responses are good enough to work; however, the inventive circular design has improved performance. Also, the “square” ground coax has additional resonances at 24 GHz and 35 GHz that are not present in the inventive circular ground ball/via pattern. Thus, an improved ball coax design results from an eight ground ball circular design.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A pseudo-coaxial vertical transition comprising:
a substrate; and
a bump array disposed in a substantially concentric bump pattern upon the substrate for simulating a pseudo-coaxial vertical electromagnetic wave propagation, the bump array including a centrally disposed bump having a predetermined bump diameter, and a plurality of at least five ground bumps substantially equidistant and circularly disposed about the centrally disposed bump, wherein the predetermined bump diameter and a bump spacing of the centrally disposed bump are determined in relation to the plurality of ground bumps and a dielectric constant of air for providing a characteristic impedance.

2. The transition of claim 1, wherein the plurality of at least five ground bumps radiate from the centrally disposed bump at about the same radius for providing the characteristic impedance of about 50 ohms.

3. The transition of claim 1, wherein the substrate comprises a printed circuit board (PCB).

4. The transition of claim 1, wherein the substrate comprises a low temperature co-fired ceramic (LTCC) substrate.

5. The transition of claim 1, wherein bump array comprises a plurality of electrically conductive structures.

6. The transition of claim 5, wherein the plurality of electrically conductive structures comprises solder balls.

7. The transition of claim 5, wherein the plurality of electrically conductive structures comprises conductive resins or polymers.

8. A connection assembly comprising:
a substrate having a first surface for coupling with a high frequency transmission line having a signal conductor and a ground conductor, a second surface for coupling to the high frequency transmission line, and a body confined by the first and second surfaces and having a substrate dielectric constant, the substrate having a plurality of electrically conductive vias disposed in a substantially concentric substrate array in the body porting into the first and second surfaces, the plurality of electrically conductive vias including a centrally disposed via having a predetermined substrate diameter for interconnecting with the signal conductor of the transmission line, and a plurality of ground substrate vias spaced about the centrally disposed via for interfacing with the ground conductor of the transmission line, wherein the predetermined substrate diameter and a substrate spacing of the centrally disposed via is determined in relation to the plurality of ground vias and the substrate dielectric constant for electrically matching an impedance associated with the high frequency transmission line; and
a ball array having a plurality of electrically conductive structures disposed in a substantially concentric ball array for coupling to at least one of the first or second surfaces of the substrate, the plurality of electrically conductive structures including a centrally disposed spherical ball having a predetermined ball diameter for coupling to the signal conductor of the transmission line, and a plurality of ground balls disposed about the centrally disposed ball for coupling to the ground conductor of the transmission line, wherein the predetermined ball diameter and a ball spacing of the centrally disposed ball is determined in relation to the plurality of ground balls and a dielectric constant of air for electrically matching the impedance associated with the high frequency transmission line and the impedance associated with the substrate.

9. The assembly of claim 8, wherein the body of the substrate comprises a plurality of layers.

10. The assembly of claim 9, wherein the plurality of layers comprises a multi-layered stack of low temperature co-fired ceramic substrates.

11. The assembly of claim 8, wherein each ball of the ball array is axially aligned with each via of the plurality of electrically conductive vias.

12. The assembly of claim 8, wherein the impedance is about 50 ohms.

13. The assembly of claim 8, wherein the high frequency transmission line comprises a co-planar waveguide (CWG) having at least one ground substrate via recessed below the signal conductor of the CWG.

14. The assembly of claim 8, wherein the high frequency transmission line comprises a micro-strip, wherein each of the ground substrate vias are recessed below the signal conductor and opens into the ground conductor of the micro-strip and the ground conductor has an aperture for allowing the central disposed via to protrude to the signal conductor.

15. The assembly of claim 8, wherein each of the electrically conductive vias comprises an electrically conductive coated cylinder.

16. The assembly of claim 8, wherein the plurality of ground balls comprises at least five balls substantially circularly, equi-distant, and peripherally spaced around the centrally disposed ball.

17. The assembly of claim 8, wherein the high frequency transmission line comprises a co-planar waveguide with ground (CWGG) having at least one ground substrate via recessed below the signal conductor and a lower ground conductor of the CWGG, wherein the lower ground conductor has an aperture for allowing the centrally disposed via to protrude to the signal conductor.

18. The assembly of claim 8, wherein the high frequency transmission line comprises a stripline, wherein each of the ground substrate vias are recessed below the signal conductor and opens into a lower ground conductor of the stripline and the lower ground conductor has an aperture for allowing the central disposed via to protrude to the signal conductor, the ground conductors vertically equidistant from the stripline signal conductor, and the ground conductors are interconnected with ground substrate vias.

19. The assembly of claim 8, wherein the high frequency transmission line comprises a substantially coaxial line.

20. An optical-electronic interconnection assembly comprising:
a planar high frequency transmission line having a central conductor and a ground conductor;
a substrate having a first surface for interfacing with the planar high frequency transmission line, a second surface for coupling to the high frequency transmission line, and a body confined by the first and second surfaces and having a substrate dielectric constant, the substrate having a plurality of electrically conductive vias disposed in a substantially concentric substrate array in the body porting into the first and second surfaces, the plurality of electrically conductive vias including a centrally disposed via having a predetermined substrate diameter for interfacing with the central conductor of the planar transmission line, and a plurality of ground substrate vias spaced about the centrally disposed via for interfacing with the ground conductor of the planar transmission line, wherein the predetermined substrate diameter and a substrate spacing of the centrally disposed via is determined in relation to the plurality of ground vias and the substrate dielectric constant for electrically matching an impedance associated with the high frequency planar transmission line; and
a ball array having a plurality of electrically conductive structures disposed in a substantially concentric ball array for coupling to the second surface of the substrate, the plurality of electrically conductive structures including a centrally disposed spherical ball having a predetermined ball diameter for coupling to the central conductor of the transmission line, and a plurality of at least eight ground balls disposed about the centrally disposed ball for coupling to the ground conductor of the transmission line, wherein the predetermined ball diameter and a ball spacing of the centrally disposed ball is determined in relation to the plurality of ground balls and a dielectric constant of air for electrically matching the impedance associated with the high frequency planar transmission line and the impedance associated with the substrate such that the ball spacing of the centrally disposed ball matches the substrate spacing of the centrally disposed via.
